(19) United States
(12) Patent Application Publication
(10) Pub. No.: US 2006/0117071 A1
(43) Pub. Date: Jun. 1, 2006

(54) Recording apparatus including a plurality of data blocks having different sizes, file managing method using the recording apparatus, and printing apparatus including the recording apparatus

(75) Inventor: Sergey Sobko, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/288,395

(22) Filed: Nov. 29, 2005

(30) Foreign Application Priority Data
Nov. 29, 2004 (KR) 2004-0098692

(51) Int. Cl. G06F 17/30

(52) U.S. Cl. 707/200

(57) ABSTRACT

A recording apparatus including a plurality of data blocks having different sizes, a file managing method using the apparatus, and a printing apparatus including the apparatus are provided. The recording apparatus includes a memory unit including a plurality of data blocks having different sizes, and a controlling unit for storing a file in the memory unit and/or reading the file from the memory unit according to a command. The controlling unit reads metadata including file type information on the type of the file, stores the files having the same types in the data blocks having the same sizes according to the metadata of the file to be stored and adds block address information on the stored data blocks to the metadata, upon receiving a storing command, and reads the file from the data block in which the file is stored according to the metadata of the file to be read, upon receiving a reading command. The access rate of the recording apparatus is improved and the operation rate of the printing apparatus is improved.

### CROSS-REFERENCE TO RELATED APPLICATIONS

This application claims the benefit under 35 U.S.C. § 119(a) of a Korean Patent Application, assigned Serial No. 10-2004-0098692, filed on Nov. 29, 2004, in the Korean Intellectual Property Office, the entire disclosure of which is hereby incorporated by reference.

### BACKGROUND OF THE INVENTION

1. Field of the Invention

The present invention relates to a recording apparatus. More particularly, the present invention relates to a recording apparatus comprising a plurality of data blocks having different sizes, a file managing method using the recording apparatus and a printing apparatus using the recording apparatus.

2. Description of the Related Art

According to advancements in multimedia technologies, the size of a multimedia file has increased very much. Thus many types of recording apparatuses for storing multimedia files have been used. Examples of these apparatuses comprise semiconductor memory card type recording apparatuses as well as conventional disc type recording apparatuses, such as hard discs and compact discs.

Particularly, a printing apparatus having a reader for reading a memory card, which stores image information photographed by using an image photographing apparatus such as a digital camera, is widely used. The use of this apparatus is advantageous in that the image information can be simply printed without an image processing apparatus such as a separate computer.

Various file systems are used for storing a multimedia file in a recording apparatus. Thus the size of files which can be stored in the recording apparatus relies on the file system and accessibility of the file. Also, the file system affects the availability, rate and security of the recording apparatus. Generally, examples of the file system comprise FAT16, FAT32, NTFS and UFS.

The file allocation table (FAT) is a file arrangement table maintained in the recording apparatus by an operating system. That is, FAT provides a map of clusters in which the files are stored. The cluster refers to a logical unit of storing the file on a recording medium and is managed by the operating system. The FAT file system used in the Windows OS comprises FAT16, FAT32 and NTFS. The number attached to the FAT represents the number of bits, in other words, 16 bits and 32 bits, respectively. The FAT16 and FAT32 are different from each other in a maximum storing capability and the total number of the clusters which can exist in one drive.

In case of a recording apparatus using the FAT16, the total number of the clusters which can exist in one drive is equal to 216, in other words, 65,536. When a new file is stored, the file is stored in at least one cluster, and the file occupies at least one cluster although the file size is smaller than that of the cluster. Accordingly, the capacity of the cluster is not fully used. The FAT16 is used in MS-DOS and Windows 95. In the FAT16, four partitions having a size of at most 2 GB can be generated. For example, if a hard disc having the size of 10 GB is used, four partitions having the sizes of 2 GB are generated and the remained space of 2 GB can not be used. Accordingly, since the maximum capability which can be used in the case of the FAT16 is 8 GB, the FAT16 is not suitable for a recording apparatus with large storage capacity. Also, the FAT16 can not use a long file name, because it is limited to a file name of a 8.3 form, which denotes 8 letters of extension name and 3 letters of extension.

FAT32 is a system used in a Windows version developed after Widows 95. Unlike the FAT16, the FAT32 is suitable for a large hard disc having a size of 2 TB (2,000 GB) and can support a long file name of up to 255 letters.

A new technology file system (NTFS) is mainly used in a server operating system such as Windows NT. The NTFS has a merit in that data security and control right on a specific file are provided, which does not exist in the FAT32. That is, unlike the FAT, the NTFS comprises a security system. The NTFS can establish an access right on a separate file and can protect the file and folder from a remote or local intruder using the security system. In order to read or write specific file, the access right on the corresponding file should be permitted. Even in case of the FAT, a file located on a network can be protected by a sharing function and can not be protected from the local intruder. In case of the FAT, the intruder using a local computer can use the file of which usage is restricted without limit. On the other hand, the rate of the NTFS is smaller than that of the FAT because an overhead is generated due to the addition of various functions which do not exist in the FAT.

A unified file system (UFS) is a file system mainly used in UNIX. The size of the data block of the UFS is generally 512 bytes or 2 KB as a basic value and is suitable for the case that small files are numerous. However, if several large files are expected to be provided, the UFS cannot be optimized.

The conventional file system has a hierarchy for classifying various files.

FIG. 1 is a diagram illustrating a conventional file system.

One file system comprises a plurality of hierarchical folders. In the lower layer of a folder 1, a folder 4 and a folder 5 exist and, in the lower layer of the folder 5, a folder 9 and a folder 10 exist. By this manner, the folders (folder 1 through folder 10) hieratically exist. This hierarchical structure has a merit in that the plural files can be systematically managed, but is disadvantageous in that the accessibility on a desired file is deteriorated. For example, when trying to access the file 5, the file system should pass four steps in the order of folder 1->folder 5->folder 10->file 5. Accordingly, it takes much time to access the file when the hierarchical structure is complicated.

Also, in the conventional file system, all the plural data blocks have the same sizes.

FIG. 2 is a diagram illustrating a conventional recording medium.

The recording medium 200 comprises a file allocation table 260 and a memory unit 250. The file allocation table 260 stores information on the address and the size of the stored file. The memory unit 250 comprises a plurality of data blocks 290, which have the same sizes. If the data blocks have the same sizes, the information stored in the file allocation table 260 is increased, because many data blocks are used when storing a large file. This becomes serious in case that the stored information is a large multimedia file. Also, if fragmentation is generated in the recording medium 200, it takes much time to retrieve one file because the file is divided and stored in data blocks which are separated from each other.

Accordingly, a file system which can improve the access rate of a file and can prevent file fragmentation is required.

### SUMMARY OF THE INVENTION

An object of the present invention is to provide a recording apparatus which employs a file system having an improved file access rate and a file managing method using the recording apparatus.

Another object of the present invention is also to provide a recording apparatus which employs a file system which can prevent the fragmentation of a data block and a file managing method using the recording apparatus.

Still another object of the present invention is also to provide a printing apparatus having an improved operating rate, which comprises a recording apparatus comprising an improved file system.

According to an exemplary embodiment of the present invention, a recording apparatus is provided. The recording apparatus comprises a memory unit comprising a plurality of data blocks having different sizes, and a controlling unit for storing a file in the memory unit and/or reading the file from the memory unit according to a command. The controlling unit reads metadata comprising file type information on the type of the file, upon receiving a storing command, stores the files having the same types in the data blocks having the same sizes according to the metadata of the file to be stored and adds block address information on the stored data blocks to the metadata, and, upon receiving a reading command, reads the file from the data block in which the file is stored according to the metadata of the file to be read.

According to an exemplary embodiment of the present invention, the metadata may further comprise sub-file information comprising block address information on at least one sub-file divided by a predetermined division criterion from the stored file, and the controlling unit may store the sub-files in the memory unit and/or may read the sub-files from the memory unit by using the sub-file information.

According to an exemplary embodiment of the present invention, the controlling unit may update the sub-file information using the block address information of the data block in which the sub-file is stored, upon receiving the storing command, and may receive the sub-file information of the file to be read and may read the sub-files from the data blocks in which the sub-files are stored according to the received sub-file information, upon receiving the reading command.

According to an exemplary embodiment of the present invention, the division criterion may be each page of an image file comprising a plurality of pages or the date on which the image file is generated.

According to an exemplary embodiment of the present invention, the controlling unit may further comprise a file type determining unit classifying the file into an image file, a document file, and other file.

According to another aspect of the present invention, a file managing method using a recording apparatus comprising a plurality of data blocks having different sizes is provided. The method comprises the steps of determining the size of the data block corresponding to the type of a file and determining a metadata region for storing metadata comprising file type information on the type of the file and a memory region for storing the data blocks based on the size of the data block, storing the files having the same types in the data blocks having the same sizes and adding block address information on the stored data block to the metadata, and receiving the metadata of the file to be read from the metadata region and reading the file from the data blocks in which the file is stored according to the received metadata.

According to an exemplary embodiment of the present invention, the storing of the files may comprise looking up an empty block list table on empty data blocks, dividing the file into at least one sub-file by a predetermined division criterion, storing the sub-files in the empty data blocks, and updating the sub-file information on the addresses of the data blocks in which the sub-files are stored to the metadata.

According to an exemplary embodiment of the present invention, the receiving the metadata and reading of the file may comprise reading the sub-file information from the metadata, and reading the sub-file from the memory region using the sub-file information.

According to an exemplary embodiment of the present invention, the division criterion may be each page of an image file comprising a plurality of pages or the date on which the image file is generated.

According to another aspect of the present invention, a printing apparatus is provided. The printing apparatus comprises an image information receiving unit for receiving a file to be printed, a memory unit comprising a plurality of data blocks having different sizes for storing the received file, a printing unit for reading and printing the file from the memory unit, and a memory controlling unit for storing the file to the memory and/or reading the file from the memory according to a command. The memory controlling unit, upon receiving a storing command, stores the files having the same type in the data blocks having the same sizes according to metadata comprising file type information on the type of the file to be stored and adds block address information on the stored data blocks to the metadata, and, upon receiving a reading command, reads the file from the data block in which the file is stored according to the metadata.

According to an exemplary embodiment of the present invention, the metadata may further comprise sub-file information comprising block address information of at least one sub-file divided by a predetermined division criterion from the stored file, and the memory controlling unit may store the sub-files in the memory unit and/or may read the sub-files from the memory unit using the sub-file information.

According to an exemplary embodiment of the present invention, the controlling unit may update the sub-file information using the block address information of the data block in which the sub-file is stored, upon receiving the storing command, and may receive the sub-file information of the file to be read and may read the sub-files from the data blocks in which the sub-files are stored according to the received sub-file information, upon receiving the reading command.

According to an exemplary embodiment of the present invention, the division criterion may be each page of an image file comprising a plurality of pages or the date on which the image file is generated.

According to an exemplary embodiment of the present invention, the file access rate of the recording apparatus is improved.

Also, according to an exemplary embodiment of the present invention, the fragmentation of the data block can be reduced and the operation rate of the printing apparatus is improved.

### BRIEF DESCRIPTION OF THE DRAWINGS

The above and other features and advantages of the present invention will become more apparent by describing in detail exemplary embodiments thereof with reference to the accompanying drawings in which:

FIG. 1 is a diagram illustrating a conventional file system;

FIG. 2 is a diagram illustrating a conventional recording medium;

FIG. 3 is a diagram illustrating a recording medium included in a recording apparatus according to an exemplary embodiment of the present invention;

FIG. 4 is a diagram illustrating a process of storing and reading a file using metadata in the recording apparatus according to an exemplary embodiment of the present invention;

FIG. 5 is a block diagram illustrating a printing apparatus according to an exemplary embodiment of the present invention;

FIG. 6 is a diagram illustrating a file type table included in the metadata illustrated in FIG. 4;

FIG. 7 is a diagram illustrating a file list table included in the metadata illustrated in FIG. 4;

FIG. 8 is a diagram illustrating a sub-file list table included in the metadata illustrated in FIG. 4;

FIG. 9 is a diagram illustrating an empty block list table included in the metadata illustrated in FIG. 4;

FIG. 10 is a flowchart illustrating a file storing operation of a file managing method according to an exemplary embodiment of the present invention; and

FIG. 11 is a flowchart illustrating a file reading operation of a file managing method according to an exemplary embodiment of the present invention.

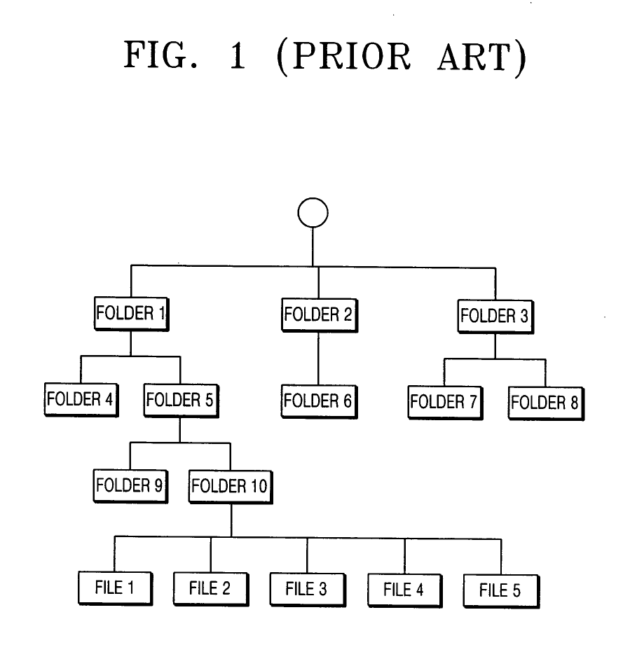

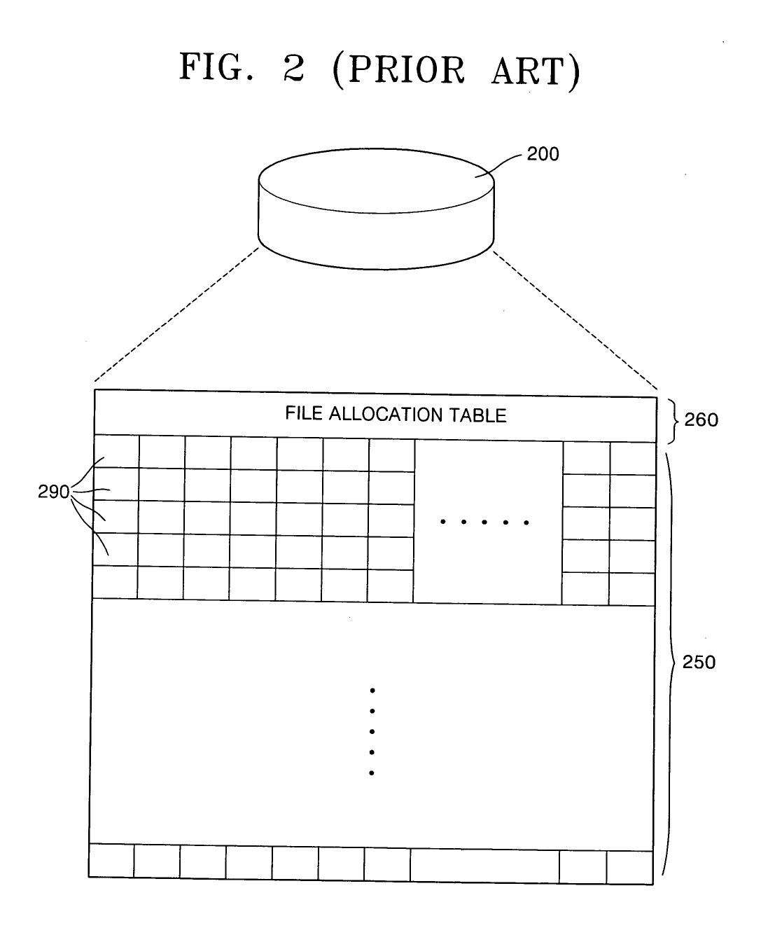

Throughout the drawings, like reference numerals will be understood to refer to like parts, components and structures.

### DETAILED DESCRIPTION OF EXEMPLARY EMBODIMENTS

Hereinafter, the present invention will be described in detail by explaining exemplary embodiments of the invention with reference to the accompanying drawings.

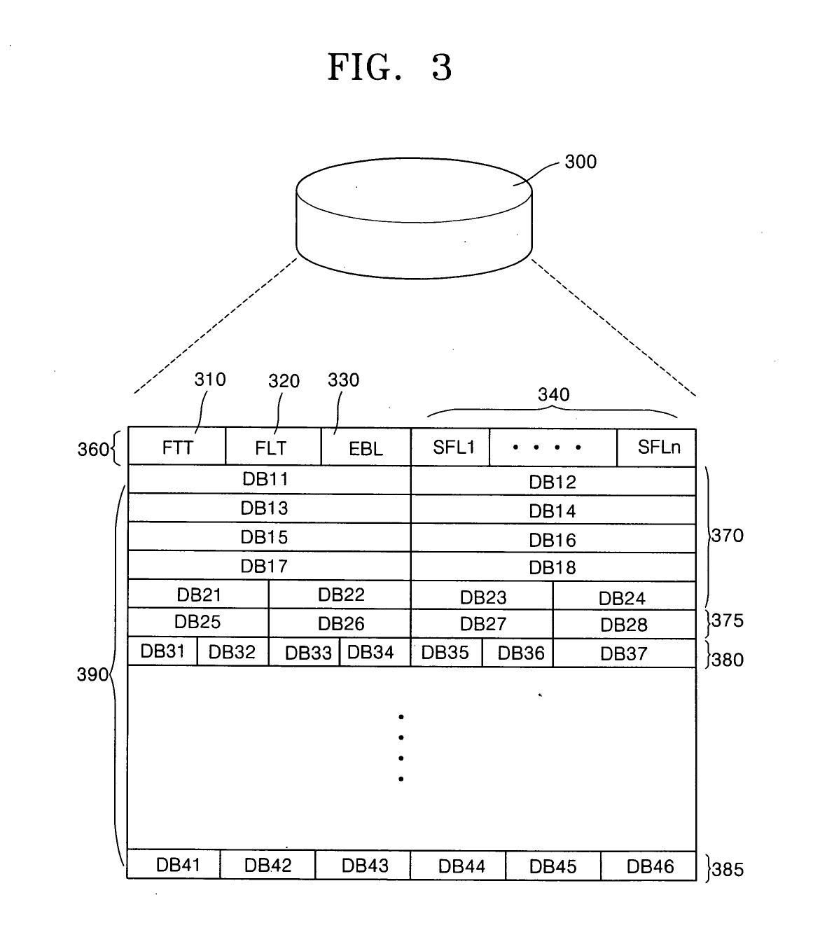

FIG. 3 is a diagram illustrating a recording medium included in a recording apparatus according to an exemplary embodiment of the present invention. The recording medium 300 comprises a metadata unit 360 and a memory unit 390. The metadata unit 360 comprises a file type table (FTT) 310, a file list table (FLT) 320, an empty block list table (EBL) 330 and a sub-file list table 340. The memory unit 390 comprises first through fourth data block groups 370, 375, 380 and 385. Each of the data block groups 370, 375, 380 and 385 comprises data blocks having the same size. In the exemplary embodiment illustrated in FIG. 3, the first data bock group 370 comprises 8 data blocks DB11, DB12, . . . DB17 and DB18, and the second data block group 375 comprises 8 data blocks DB21, DB22, . . . DB27 and DB28. The third data bock group 380 comprises 7 data blocks DB31, DB32, . . . DB36 and DB37, and the fourth data block group 385 comprises 6 data blocks DB41, DB42, . . . DB45 and DB46.

The file type table (FTT) 310 comprises the information on the type of the stored file. For example, the stored file can be classified into an image file, a document file, an operation history file and a system file. These files are allocated with the data blocks having the sizes corresponding to the file types. The image file is obtained by using a scanner or a digital camera. Also, the image file may comprise several pages. For example, when scanning a book having 100 pages, one image file having 100 pages is obtained. Each of the pages can be managed by using sub-file information and the description thereof will be made in greater detail later. The size of the image file is different according to the resolution and can reach several Megabytes. Accordingly, it is preferable that the data block for storing the image file has a large size.

The document file comprises an established font and the size of the document file is smaller than that of the image file. Accordingly, the data block having the size smaller than that of the data block for storing the image file can be used for storing the document file.

The operation history file stores the history of the operations of the recording apparatus according to an exemplary embodiment of the present invention. In case the recording apparatus according to an exemplary embodiment of the present invention is used in the digital camera, the information such as the total number of the pictures photographed by the digital camera, the date when the picture is photographed, time and focus distance, flash usage, and aperture may be stored. Since the operation history file is constructed by a text, the data block having the size smaller than that of the data block for storing the image file can be used.

The system file comprises information useful for the operation of the apparatus comprising the recording apparatus according to an exemplary embodiment of the present invention. For example, in case that the recording apparatus according to an exemplary embodiment of the present invention is used in a printer, the system file may comprise internal fonts of the printer, macro operations of the printer and internal watermarks of the printer. Since the operation history file is also constructed by a text, the data block having the size smaller than that of the data block of storing the image file can be used.

The structure and the operation of the file type table (FTT) 310 will be described in detail later.

The file list table (FLT) 320 stores the list of the stored files. Since the recording apparatus according to an exemplary embodiment of the present invention stores the file using the data blocks having the different sizes according to the file type, it is preferable that the file list is also managed according to the file type. For example, it is preferable that the file list table of storing the list of the image files and the file list table of storing the list of the document files are separately stored. The file list is not necessarily constructed using the file name. Unlike the conventional file system, the file system employed in the recording apparatus according to an exemplary embodiment of the present invention can classify the file by various criteria such as a user, a date, version information, in addition to the file name.

The structure and the operation of the file list table (FLT) 320 will be described in the corresponding portion in the present specification in detail.

The empty block list table (EBL) 330 stores the empty data block list of the memory unit 390 in the recording medium 300. In case of trying to store the file in the recording medium 300, the empty block list table (EBL) 330 is looked up to find the empty data block. For example, in case of storing the image file, it is checked whether the empty data block exists in the data blocks DB11, DB12, DB17 and DB18 for storing the image file by the empty block list table 330.

The structure and the operation of the empty block list table (EBL) 330 will be described in detail later.

The sub-file list table 340 comprises information on the addresses of the data blocks in which the sub-files comprising one file are stored. In the present specification, the sub-file represents the lower file comprising one file. There are various methods of dividing one file into sub-files. As mentioned above, the image file comprising a plurality of the pages can be divided by a page unit. In this case, one page corresponds to one sub-file. Also, the picture file which is photographed on the same date may be divided by a date unit. In this case, the picture file which is photographed on the same date corresponds to one sub-file. In the recording apparatus according an exemplary embodiment to the present invention, the hieratical file system is not used unlike the conventional technology. On the other hand, one file is divided into a plurality of the sub-files by a predetermined criterion and is managed. These features are designed by the property that image file can be divided by a simple criterion such as the date without requiring the plural hieratical structures. Accordingly, since the recording medium according to an exemplary embodiment of the present invention can immediately search a desired sub-file without searching the files of the several layers, the access rate is improved.

In the embodiment illustrated in FIG. 3, the sub-file list table 340 comprises a first sub-file list SFL1 through an n-th sub-file list SFLn. Each of the sub-file lists comprises sub-file information comprising the addresses of the data blocks in which the sub-files of one file are stored.

The structure and the operation of the sub-file list table 340 will be described in the corresponding portion in the present specification in detail.

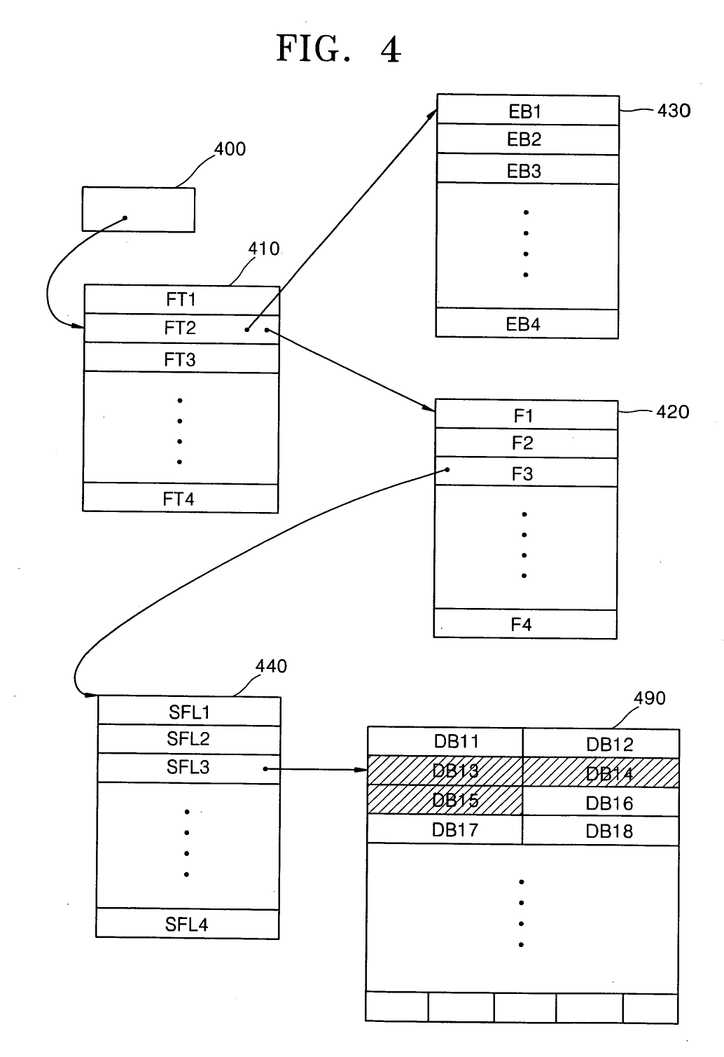

FIG. 4 is a diagram illustrating a process of storing and reading a file using metadata in the recording apparatus according an exemplary embodiment of the present invention.

First, the reference numeral 400 is a basic block. The basic block 400 denotes a temporary recording apparatus in which a file to be stored is temporarily stored. The basic block 400 is conceptually illustrated to indicate a start point of the file managing operation and is not provided to limit the present invention.

First, a process of reading the data stored in the memory unit 490 will be described.

The type of the file to be read is looked up in the file type table (FTT) 410. The file type table (FTT) 410 illustrated in FIG. 4 comprises first through fourth file types FT1, FT2, FT3 and FT4. Each of the file types FT1, FT2, FT3 and FT4 points the file list table (FLT) corresponding to the corresponding file type. For example, assume that the file to be read is the image file and corresponds to the second file type FT2. Then, the file to be read is looked up from the file list table (FLT) 420 pointed by the second file type (FT2). The file list table (FLT) 420 comprises first and fourth file lists F1, F2, F3 and F4. Each of the file lists F1, F2, F3 and F4 points the sub-file list table corresponding to the corresponding file list. For example, assume that the image file to be read corresponds to the third file list (F3). Then, the sub-file to be read is looked up from the sub-file list table 440 pointed by the third file list (F3). The sub-file list table 440 comprises first through fourth sub-file lists (SFL1, SFL2, SLF3 and SFL4). Each of the sub-file lists (SFL1, SFL2, SLF3 and SFL4) comprises information on the addresses of the data blocks in which the sub-file is stored. For example, assume that the sub-file to be read is the third sub-file and is stored in 3 consecutive data blocks. Then, the data block pointed by the third sub-file list SFL3 is read from the memory unit 490. In FIG. 4, the sub-files stored in the third through fifth blocks (DB13, DB14 and DB15) are read.

Hereinafter, a process of storing the data in the memory unit 490 will be described.

The file to be stored is temporarily stored in the basic block 400. Then, the type of the file to be stored is looked up in the file type table (FTT) 410. For example, assume that the file to be stored corresponds to the second file type (FT2). Then, the empty block list table (EBL) 430 pointed by the second file type (FT2) is looked up to find the empty data block. As mentioned above, since the recording apparatus according to an exemplary embodiment of the present invention stores the file in the data blocks having the different sizes according to the file type, it is preferable that the different empty block list table (EBL) 430 is provided according to the file type. If the empty data block is found, the file is stored in the found empty data block. In this case, the file is stored by the sub-file unit and the information on the addresses of the data blocks in which the sub-files are stored is stored in the sub-file list table 440. Also, the used data blocks are deleted from the empty block list table (EBL) 430.

The structure of the file type table (FTT) 410, the file list table (FLT) 420, the empty block list table (EBL) 430, the sub-file list table 440 and the memory unit 490 illustrated in FIG. 4 is exemplary and is not provided to limit the scope of the present invention.

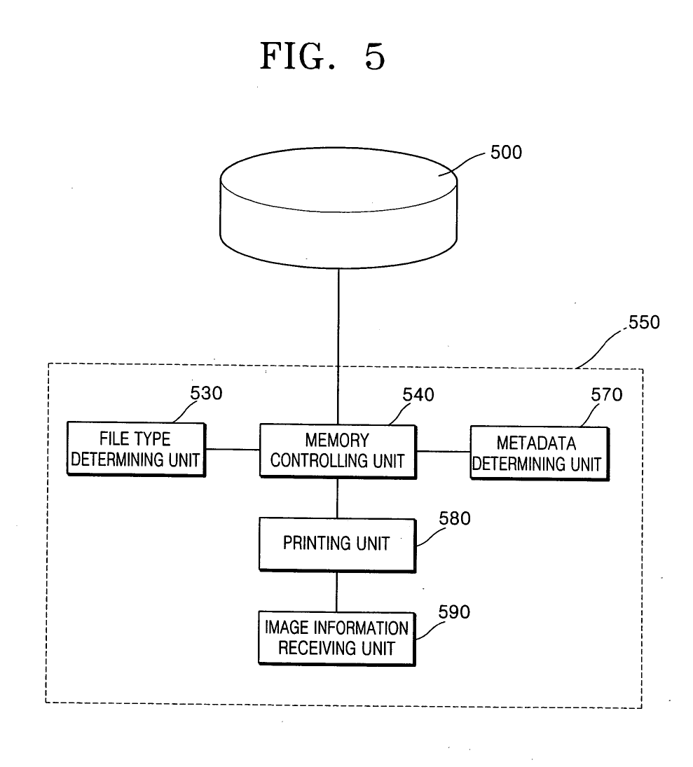

FIG. 5 is a block diagram illustrating a printing apparatus according to an exemplary embodiment of the present invention.

The printing apparatus comprises an image information receiving unit 590 for receiving a file to be printed, a memory unit 500 for storing the received file, a printing unit 580 for reading and printing the file from the memory unit and a memory controlling unit 540 for storing and reading the file in the memory unit according to a received command. The memory unit 500 comprises a plurality of the data blocks (not shown) having the different sizes and stores the files having the same types in the data blocks having the same sizes. Also, the printing apparatus illustrated in FIG. 5 further comprises a metadata determining unit 570 and a file type determining unit 530.

The metadata determining unit 570 reads the metadata comprising the file type information on the type of the stored file. The file type determining unit 530 can classify the stored file into the image file, the document file, the operation history file and the system file.

The memory controlling unit 540 stores the files having the same type in the data blocks having the same sizes and adds the block address information on the stored data blocks to the metadata. Also, the memory controlling unit 540 reads the file from the data block in which the file is stored according to the metadata. As mentioned above, the metadata further may comprise the sub-file information comprising the block address information of at least one sub-file comprising the stored file. In this case, the memory controlling unit 540 can store or read the file by the sub-file unit using the sub-file information. Also, the metadata may further comprise at least one of the name, the size and the version information of the stored file. The version information is used for identifying the modified version when the same file is modified several times. Accordingly, the files having the same names can be identified by the version information.

The printing unit 580 receives the file to be printed from the memory controlling unit 540 and prints the file using a predetermined printing method. For example, the printing unit 580 can print the file by an electrophotographic method.

In FIG. 5, the metadata determining unit 570 and the file type determining unit 530 are illustrated as the devices separated from the memory controlling unit 540 and the scope of the present invention is not limited to this. Rather, both the metadata determining unit 570 and the file type determining unit 530 may be assembled in the memory controlling unit 540.

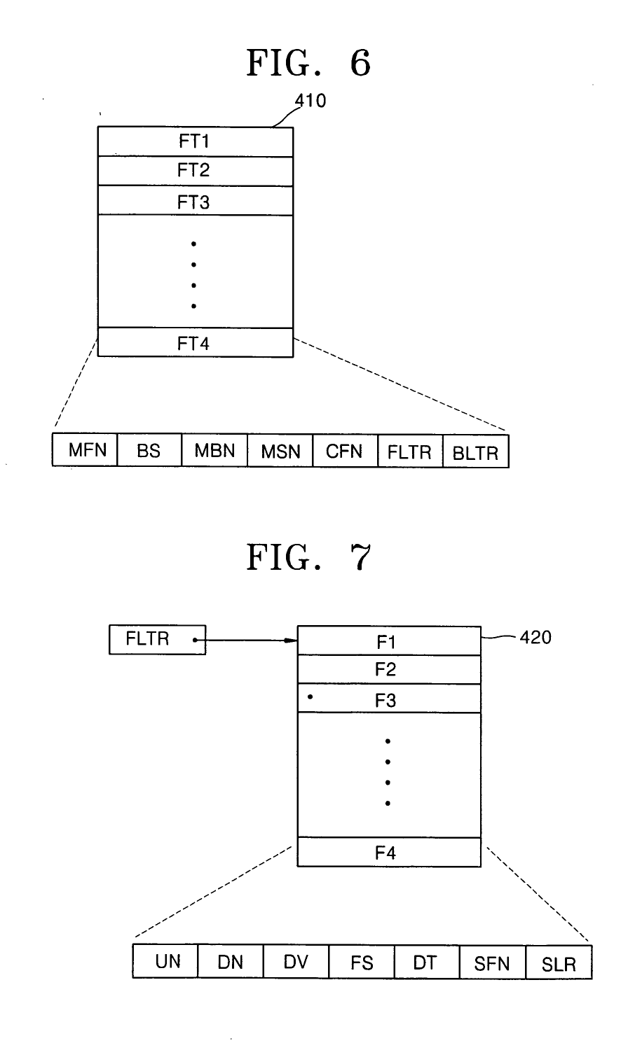

FIG. 6 is a diagram illustrating a file type table included in the metadata illustrated in FIG. 4. The file type table (FTT) 410 comprises the first through fourth file types (FT1, FT2, FT3 and FT4). Each of the file types comprises a maximum file number (MFN) entry, a block size entry, a maximum block number per file (MBN) entry, a maximum sub-file number per file (MSN) entry, a current file number (CFN) entry, a reference to corresponding file list table (FLTR) entry and a reference to corresponding block list table (BLTR) entry. The file type table (FTT) 410 may be generated in an initiating process and the entries comprising the file type table (FTT) 410 are changed. The FLTR entry points the file list table of the corresponding type.

FIG. 7 is a diagram illustrating a file list table included in the metadata illustrated in FIG. 4. The file list table (FLT) 420 comprises the first through fourth file lists (F1, F2, F3 and F4). Each of the file lists comprises a user name (UN) entry, a document name (DN) entry, a document version (DV) entry, a file size (FS) entry, a storing date (DT) entry, a sub-file number (SFN) entry and a reference to sub-file list (SLR) entry. The file list table (FLT) 420 may be generated in the initiating process and the entries comprising the file list table (FLT) 420 may be changed. The SLR entry points the sub-file list table of the corresponding sub-file.

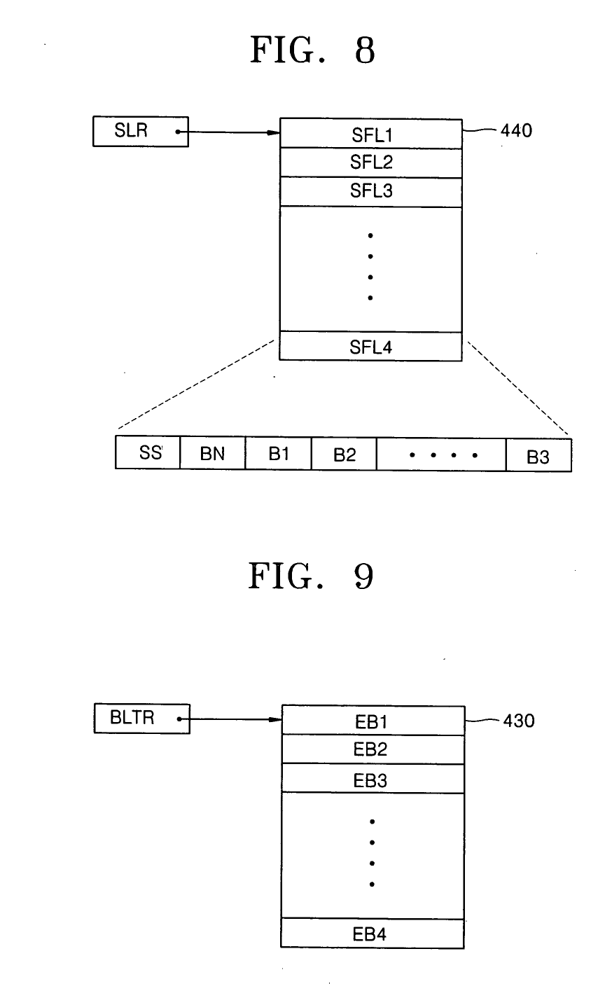

FIG. 8 is a diagram illustrating a sub-file list table included in the metadata illustrated in FIG. 4.

The sub-file list table 440 comprises the first through fourth sub-file lists (SFL1, SFL2, SFL3 and SFL4). Each of the sub-file lists comprises a sub-file size (SS) entry, a block number per sub-file (BN) entry and first through third data block addresses (B1, B2, B3) entries. As mentioned above, the block addresses point the addresses of the data blocks in which the sub-files are stored. The sub-files stored in the consecutive data blocks can be simply read using the address of the start data block and the block number (BN) entry.

FIG. 9 is a diagram illustrating an empty block list table included in the metadata illustrated in FIG. 4.

The empty block list table (EBL) 430 stores the empty data block list in the memory unit 390 of the recording medium 300. The empty block list table 430 illustrated in FIG. 9 comprises the first through fourth empty data block lists (EB1, EB2, EB3 and EB4). As mentioned above, it is preferable that the empty block list table 430 is separately provided according to the file type. Each of the empty block list table 430 is pointed by the reference to corresponding block list table (BLTR) entry included in the file type table 410 illustrated in FIG. 6.

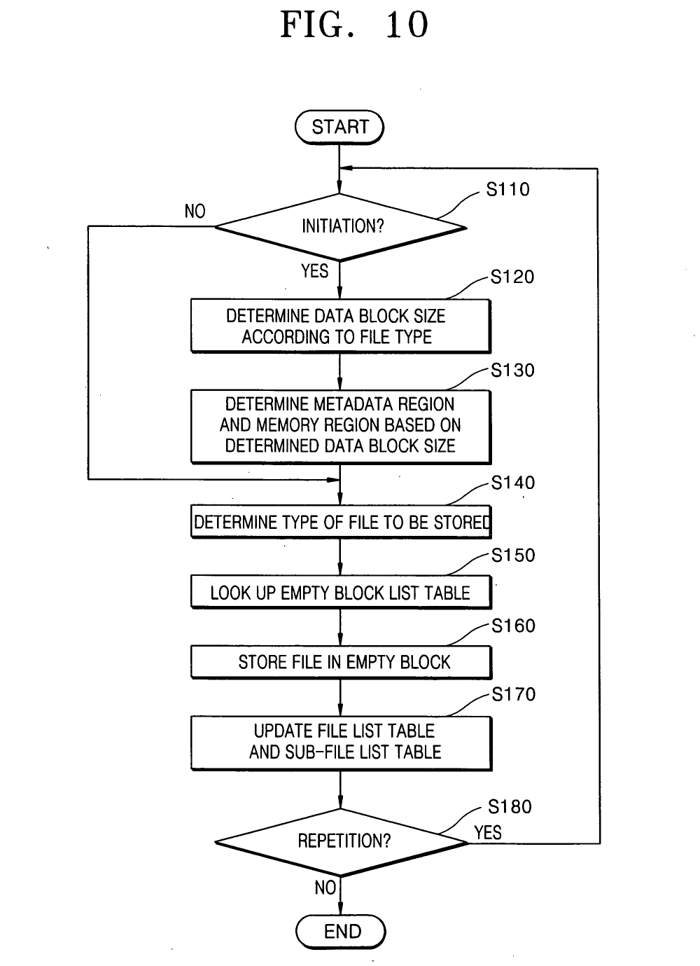

FIG. 10 is a flowchart illustrating a file storing operation of a file managing method according to an exemplary embodiment of the present invention.

First, it is determined whether the initiation operation is performed at step S110. The initiation operation may be performed in the process of manufacturing the recording apparatus according to an exemplary embodiment of the present invention or may be performed when in a new printing apparatus first using the recording apparatus. If the initiation operation is performed, the size of the data block is determined according to the file type at step S120. As mentioned above, since the recording apparatus according to an exemplary embodiment of the present invention stores the file using the data blocks having the different sizes according to the file type, the size of the data block suitable for each file is previously determined. It is preferable that the size of the data block for storing the image file is greater than that of the data block for storing the different types of the files.

Then, the metadata region and the memory region are determined based on the size of the determined data block at step S130. The metadata region may comprise the file type, the file list, the file size and the version information, as mentioned above.

When storing the file, the type of the file to be stored is determined at step S140. Then, the empty block list table corresponding to the determined file type is looked up at step S150. The empty block list table comprises the list of the empty data blocks in the data blocks having the different sizes according to the file type. If the empty data block is looked up from the empty block list table, the file is stored in the empty block at step S160. Then, the file list table is updated using the address of the data block in which the file is stored at step S170. As mentioned above, the file managing method according to an exemplary embodiment of the present invention may divide the file into the sub-files and store the file by the sub-file unit. In this case, the sub-file list table is updated by using the address of the data blocks in which the sub-files are stored at step S170.

If the storing operation of the file is finished, it is determined whether the other file must be stored and, if so, the above-mentioned operations are repeated at step S180.

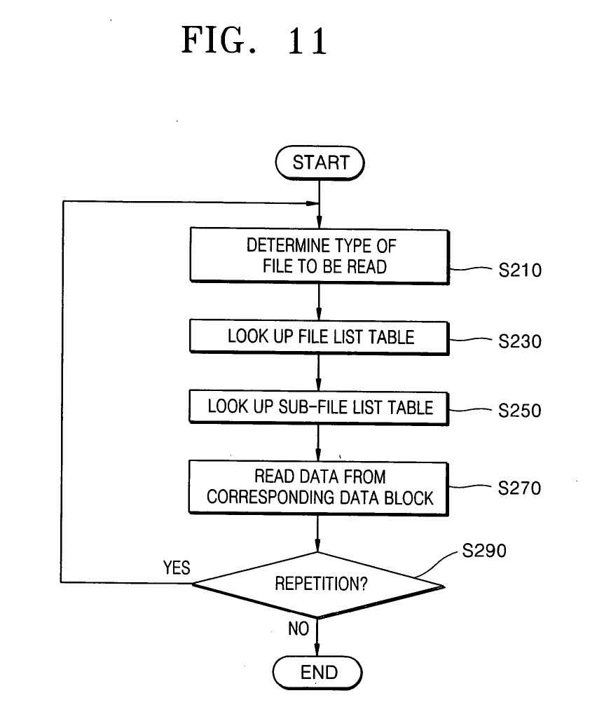

FIG. 11 is a flowchart illustrating a file reading operation of a file managing method according to an exemplary embodiment of the present invention.

First, the type of the file to be read is determined at step S210. Then, the file list table is looked up using the determined type at step S230. The file list table stores the list of the files having the same type as the corresponding file. If the file list to be read is looked up from the file list table, the sub-file to be read is looked up from the sub-file list table at step S250. The sub-file list table comprises the addresses of the data blocks in which the sub-files comprising the file to be read are stored. If the addresses of the data blocks in which the sub-files to be read are stored are looked up from the sub-file list table, the data is read from the corresponding data block at step S270.

If the reading operation of the file is finished, it is determined whether the other file must be read, and, if so, the above-mentioned operations are repeated at step S290.

According to an exemplary embodiment of the present invention, since the file is stored by using the data block having a suitable size according to the type of the stored file, the waste of the data block can be reduced and the fragmentation of the data block can be prevented. For example, in order to store the operation list file, the data block having the size smaller than that of the data block for storing the image file is used. Accordingly, the fragmentation of the data block is prevented, compared with the case that the operation list file is stored by using the data block having the same size as the data block for storing the image file.

On the other hand, the function of the memory controlling unit included in an exemplary embodiment of the present invention can be written as computer programs. Also, the file managing method according to an exemplary embodiment of the present invention can be implemented in general-use digital computers that execute the programs using a computer readable recording medium.

Examples of the computer readable recording medium comprise magnetic recording media, such as ROM, floppy disks and hard disks, optical recording media, such as CD-ROMs and DVDs, and recording media such as carrier waves, such as transmission through the Internet.

Hereinafter, several computer program commands for performing the functions of exemplary embodiments of the present invention will be described.

Initiating command
Description: The logical format operation of the recording medium is performed and the memory region and the metadata region are established.
Input parameter: number of types, file type table (FTT)
Output parameter: operation result

Command for reading the list number of file type table (FTT)
Input parameter: file type index
Output parameter: file list number in one file type table (FTT)

Command for reading file list in file type table (FTT)
Input parameter: file type index
Output parameter: file list (identified by the identification criteria such as the user name, the document name and the version information)

File version number reading command
Input parameter: file type index, user name, document name
Output parameter: number of versions

Sub-file number reading command
Input parameter: file type index, user name, document name, version information
Output parameter: number of sub-files

File size reading command
Input parameter: file type index, user name, document name, version information
Output parameter: file size

File generating command
Input parameter: file type index, user name, document name
Output parameter: operation result, version information

File opening command
Input parameter: file type index, user name, document name, version information
Output parameter: file descriptor

File writing command
Input parameter: file descriptor, number of sub-files, data buffer, data size
Output parameter: operation result

File reading command
Input parameter: file descriptor, number of sub-files, data buffer, data size
Output parameter: operation result, actual size of received data

Command for rearranging sub-files in files
Description: This is the command for resetting the positions of the sub-files in previously opened file.
Input parameter: file descriptor, sub-file number, new position
Output parameter: new position

File closing command
Input parameter: file descriptor
Output parameter: operation result

Command for deleting all versions of file
Input parameter: file type index, user name, document name
Output parameter: operation result

The above-mentioned commands are exemplary and provided to understand the present invention and various changes thereof may be made.

While the present invention has been particularly shown and described with reference to exemplary embodiments thereof, it will be understood by those of ordinary skill in the art that various changes in form and details may be made therein without departing from the spirit and scope of the present invention as defined by the appended claims. For example, although one file is divided into a plurality of the sub-files and is managed according to an exemplary embodiment of the present invention, it is apparent that the sub-files may be further divided into minute sub-files and be managed.

According to an exemplary embodiment of the present invention, it is possible to provide a recording apparatus which employs a file system having an improved file access rate and a file managing method using the recording apparatus.

Also, it is possible to provide a recording apparatus which employs a file system capable of preventing the fragmentation of a data block and a file managing method using the recording apparatus.

Furthermore, it is possible to provide a printing apparatus having an improved operation rate, the printing apparatus including the recording apparatus which employs the improved file system according to the present invention.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A recording apparatus comprising:
a memory unit comprising a plurality of data blocks having different sizes; and
a controlling unit for storing a file in the memory unit and/or reading the file from the memory unit according to a command,
wherein the controlling unit reads metadata comprising file type information on the type of the file, upon receiving a storing command, stores the files of the same type in the data blocks having the same size according to the metadata of the file to be stored and adds block address information on the stored data blocks to the metadata, and upon receiving a reading command, reads the file from the data block in which the file is stored according to the metadata of the file to be read.

2. The apparatus according to claim 1, wherein the metadata further comprises sub-file information comprising block address information on at least one sub-file divided by a predetermined division criterion from the stored file, and
wherein the controlling unit stores the sub-files in the memory unit and/or reads the sub-files from the memory unit using the sub-file information.

3. The apparatus according to claim 2, wherein the controlling unit updates the sub-file information using the block address information of the data block in which the sub-file is stored, upon receiving the storing command, and receives the sub-file information of the file to be read and reads the sub-files from the data blocks in which the sub-files are stored according to the received sub-file information, upon receiving the reading command.

4. The apparatus according to claim 3, wherein the division criterion comprises at least one of:
each page of an image file comprising a plurality of pages; and
the date on which the image file is generated.

5. The apparatus according to claim 1, wherein the controlling unit further comprises a file type determining unit for classifying the file into at least one of an image file, a document file and another file.

6. The apparatus according to claim 1, wherein the metadata further comprises at least one of a name, a size, a user name, and version information of the stored file.

7. A file managing method using a recording apparatus comprising a plurality of data blocks having different sizes, the file managing method comprising:
determining the size of the data block corresponding to the type of a file and determining a metadata region for storing metadata comprising file type information on the type of the file and a memory region for storing the data blocks based on the size of the data block;
storing the files having the same types in the data blocks having the same sizes and adding block address information on the stored data block to the metadata; and
receiving the metadata of the file to be read from the metadata region and reading the file from the data blocks in which the file is stored according to the received metadata.

8. The method according to claim 7, wherein the storing of the files comprises:
looking up an empty block list table on empty data blocks;
dividing the file into at least one sub-file by a division criterion;
storing the sub-files in the empty data blocks; and
updating the sub-file information on the addresses of the data blocks in which the sub-files are stored to the metadata.

9. The method according to claim 7, wherein the receiving of the metadata and reading the file comprises:
retrieving the sub-file information from the metadata; and
reading the sub-file from the memory region by using the retrieved sub-file information.

10. The method according to claim 8, wherein the division criterion comprises at least one of:
each page of an image file composing a plurality of pages; and
the date on which the image file is generated.

11. The method according to claim 7, wherein the determining of the size of the data block comprises classifying the file into at least one of an image file, a document file, and another file according to the type of the file.

12. The method according to claim 7, wherein the metadata further comprises at least one of a name, a size, a user name, and version information of the stored file.

13. A printing apparatus comprising:
an image information receiving unit for receiving a file to be printed;
a memory unit comprising a plurality of data blocks having different sizes for storing the received file;
a printing unit for reading and printing the file from the memory unit; and
a memory controlling unit for storing the file to the memory and/or reading the file from the memory according to a command,
wherein the controlling unit,
upon receiving a storing command, stores the files having the same types in the data blocks having the same sizes according to metadata comprising file type information on the type of the file to be stored, and adds block address information on the stored data blocks to the metadata, and
upon receiving a reading command, reads the file from the data block in which the file is stored according to the metadata.

14. The apparatus according to claim 13, wherein the metadata further comprises sub-file information comprising block address information of at least one sub-file divided by a division criterion from the stored file, and
wherein the memory controlling unit stores the sub-files in the memory unit and/or reads the sub-files from the memory unit by using the sub-file information.

15. The apparatus according to claim 14, wherein the memory controlling unit updates the sub-file information using the block address information of the data block in which the sub-file is stored, upon receiving the storing command, and receives the sub-file information of the file to be read and reads the sub-files from the data blocks in which the sub-files are stored according to the received sub-file information, upon receiving the reading command.

16. The apparatus according to claim 15, wherein the division criterion comprises at least one of:
each page of an image file comprising a plurality of pages; and
the date on which the image file is generated.

17. The apparatus according to claim 13, wherein the memory controlling unit further comprises a file type determining unit for classifying the file into at least one of an image file, a document file and another file.

18. The apparatus according to claim 13, wherein the metadata further comprises at least one of a name, a size, a user name, and version information of the stored file.

19. Program code embodied on a computer-readable medium for file management using a recording apparatus comprising a plurality of data blocks having different sizes, the program code comprising:
a first set of instructions for determining the size of the data block corresponding to the type of a file and determining a metadata region for storing metadata comprising file type information on the type of the file and a memory region for storing the data blocks based on the size of the data block;
a second set of instructions for storing the files having the same types in the data blocks having the same sizes and adding block address information on the stored data block to the metadata; and
a third set of instructions for receiving the metadata of the file to be read from the metadata region and reading the file from the data blocks in which the file is stored according to the received metadata.

20. Program code as claimed in claim 19, wherein said second set of instructions further comprises:
a fourth set of instructions for looking up an empty block list table on empty data blocks;
a fifth set of instructions for dividing the file into at least one sub-file by a predetermined division criterion;
a sixth set of instructions for storing the sub-files in the empty data blocks; and
a seventh set of instructions for updating the sub-file information on the addresses of the data blocks in which the sub-files are stored to the metadata.
